(19) United States
(12) Patent Application Publication
(10) Pub. No.: US 2023/0196539 A1
(43) Pub. Date: Jun. 22, 2023

(54) Artificial intelligence based method for detection and analysis of image quality and particles viewed through a microscope

(71) Applicant: ImageProVision Technology Private Limited, Pune (IN)

(72) Inventors: Prithviraj Pralhad Jadhav, Pune (IN); Sandeep Arvind Kulkarni, Pune (IN)

(21) Appl. No.: 18/083,518

(22) Filed: Dec. 17, 2022

Related U.S. Application Data
(60) Provisional application No. 63/291,362, filed on Dec. 18, 2021.

(51) Int. Cl. G06T 7/00

(52) U.S. Cl. CPC G06T 7/0002; G06T 2207/10056; G06T 2200/24; G06T 2207/30168

(57) ABSTRACT

Disclosed herein is a microphotography method and its implementing system are disclosed in this paper, whereby a sample presented on a microscopic slide is scanned by a microscope which is in turn coupled with a digital camera for capturing the field of view as seen through the microscope. Such captured image/imagery is relayed to a computer, wherein it is processed by means of software employing artificial intelligence logic to thereby detect image quality and over a precedent of past readings, allow detection and classification of particles, if any present in said sample, via machine learning approach.

### CROSS REFERENCES TO RELATED APPLICATIONS

This non-provisional patent application claims the benefit of U.S. provisional application No. 63/291,362 filed on 18 Dec. 2021, the contents of which are incorporated herein in their entirety by reference.

### STATEMENT REGARDING FEDERALLY SPONSORED RESEARCH OR DEVELOPMENT

None applicable

### REFERENCE TO SEQUENCE LISTING, A TABLE, OR A COMPUTER PROGRAM LISTING COMPACT DISC APPENDIX

None

### FIELD OF THE INVENTION

This invention relates generally to the field of image processing and particularly to applications thereof for qualitative and quantitative analyses. Specifically, a microphotography method and its implementing system are disclosed in this paper, whereby a sample presented on a microscopic slide is scanned by a microscope which is in turn coupled with a digital camera for capturing the field of view as seen through the microscope. Such captured image/imagery is relayed to a computer, wherein it is processed by means of software employing artificial intelligence logic to thereby detect image quality and over a precedent of past readings, allow detection and classification of particles, if any present in said sample, via machine learning approach.

### BACKGROUND OF THE INVENTION AND DESCRIPTION OF RELATED ART

Image processing generally refers to digitization of optical images, and performing operation(s) on the so-converted data to augment and/or extract further meaningful information, preferably in an automated manner. Signal dispensation of source data, approach for processing said input source data and interpretation of post-processing output are major areas of interdisciplinary research in field of the present invention wherein image visualization, restoration, retrieval, measurement and recognition are prime loci of progressive investigation.

Particle analysis and particle characterization are major areas of research in new drug or formulation development in pharmaceutical industry. A proper analysis of particle size and shape reduces development time to a great extent. However, most of the current microscopic analysis is done manually which requires more time besides being prone to subjective interpretation and requires an expert to take the decision.

Processing of photomicrographic images, in above parlance, is found to be employed variably in state-of-art technologies for study of microscopic particles wherein identifying indicia among their physical, chemical, compositional, morphological attributes and/or physiological behaviors are utilized for qualitative and/or quantitative determinations including identification and size distribution of the particles under study. However, such implements are presently limited to non-visual light microscopy applications such as X-ray microtomography (μCT), transmission electron microscopy (TEM), scanning electron microscopy (SEM) and the like. Therefore, it would be advantageous to have some means for availing advantages of image processing technology for visual light/optical microscopy, particularly particle analysis applications.

Conventionally, detection and classification of particles has been practiced via sieving, sedimentation, dynamic light scattering, electrozone sensing, optical particle counting, XRD line profile analysis, adsorption techniques and mercury intrusion or further indirect methods such as surface area measurements. However, resolution of these techniques leave a lot to be desired, besides relying on availability of expensive equipment and collateral prior expertise of skilled operators for arriving at the determination intended. Such analysis, as will be obvious to the reader, tends to be less reproducible due to unavoidable personal biases and therefore inaccurate for faultless determinations. There is hence a need for some way that makes possible the integration of image analytics for particle classification in optical microscopy applications.

The art therefore requires a particle identification and classification technology that is capable of plug-and-play integration in existing optical microscopy application environments with minimal bias on capital, integration and operative expenses and at the same time, being of a nature that allows accurate and precise implementation by any person even ordinarily skilled in the art. Ability to succinctly discern despite strong variability among objects of interest, low contrast, and/or high incidence of agglomerates and background noise are additional characters desirable in said particle identification and classification technology presently lacking in state-of-art.

Considering acute demands on accuracy and precision in detection and analysis of image quality and particles viewed through a microscope, it would be highly advantageous to have some way to eliminate human error, effect of fatigue and/or dependency/variations in skill sets of individuals. The applicant herein has opted for an approach involving artificial intelligence and machine learning for the same, as will be disclosed in the description to follow.

Prior art, to the limited extent presently surveyed, does not list a single effective solution embracing all considerations mentioned hereinabove, thus preserving an acute necessity-to-invent for the present inventors who, as result of their focused research, have come up with novel solutions for resolving all needs of the art once and for all. Work of the presently named inventors, specifically directed against the technical problems recited hereinabove and currently part of the public domain including earlier filed patent applications, is neither expressly nor impliedly admitted as prior art against the present disclosures.

A better understanding of the objects, advantages, features, properties and relationships of the present invention will be obtained from the underlying specification, which sets forth the best mode contemplated by the inventor of carrying out the present invention.

### OBJECTIVES OF THE PRESENT INVENTION

The present invention is identified in addressing at least all major deficiencies of art discussed in the foregoing section by effectively addressing the objectives stated under, of which:

It is a primary objective to provide an effective method for photomicrographic image-processing method for automatic scanning, detection and classification of particles present in a sample presented for photomicrography.

It is another objective further to the aforesaid objective(s) that the method so provided is error-free and lends itself to accurate implementation even at hands of a user of average skill in the art.

It is another objective further to the aforesaid objective(s) that implementation of the method so provided does not involve any complicated or overtly expensive hardware.

It is another objective further to the aforesaid objective(s) that implementation of the method is possible via a remote server, in a software-as-a-service (SaaS) model.

The manner in which the above objectives are achieved, together with other objects and advantages which will become subsequently apparent, reside in the detailed description set forth below in reference to the accompanying drawings and furthermore specifically outlined in the independent claims. Other advantageous embodiments of the invention are specified in the dependent claims.

### BRIEF DESCRIPTION OF THE DRAWINGS

The present invention is explained herein under with reference to the following drawings, in which—

FIG. 1 is a flowchart explaining the process sequence logic of the present invention.

The above drawings are illustrative of particular examples of the present invention but are not intended to limit the scope thereof. In above drawings, wherever possible, the same references and symbols have been used throughout to refer to the same or similar parts. Though numbering has been introduced to demarcate reference to specific components in relation to such references being made in different sections of this specification, all components are not shown or numbered in each drawing to avoid obscuring the invention proposed.

Attention of the reader is now requested to the brief description to follow which narrates a preferred embodiment of the present invention and such other ways in which principles of the invention may be employed without parting from the essence of the invention claimed herein.

### SUMMARY OF THE INVENTION

The present invention is directed to a artificial intelligence based method for detection and analysis of image quality and particles viewed through a microscope, using a microscope which is fitted with an imaging system such as a digital camera.

### DETAILED DESCRIPTION

Principally, general purpose of the present invention is to assess disabilities and shortcomings inherent to known systems comprising state of the art and develop new systems incorporating all available advantages of known art and none of its disadvantages. Accordingly, the present invention is directed to a computer-assisted photomicrographic image-processing method for automatic scanning, detection and classification of particles. In this method, tracking and analysis of objects of interest (namely, particulates), if any present and seen in one or more photographic images of the sample being analyzed, can be conveniently and rapidly undertaken via artificial intelligence and machine learning.

Specifically as to the hardware involved, the execution environment of the present invention involves an optical microscope having a target object for visualization, to which an imaging system such as a digital camera is associated in a manner allowing capturing of magnified imagery of the object seen via said microscope. Thus, in the recital herein, the reader shall understand that images referred for analysis are ones obtained live from said microscope or as obtained from the microscope and captured in form of images by the camera.

The target object referred above is a typically a slide bearing a sample thereon. The sample to be analyzed is prepared using standard laboratory techniques and placed on a stage of the microscope for photomicrography.

Fitment of the camera to the microscope, as mentioned above, is done via suitable fitments, brackets etcetera, used conventionally for said purpose. Captured images of the camera are captured on a memory device (such as a memory card) housed in said camera and said data is conveyed subsequently Or in real time, via a data cable, to a personal computer for further processing.

Data output of the camera is received and processed by means of an application of the present invention (named “ipvMorpho” and referred so throughout this document) being priorly installed on said personal computer. Alternatively, ipvMorpho may be hosted on the cloud, and made available in the SaaS model of implementation.

As will be realized further to the disclosures above, resolution of the present invention is correlated with optics of the microscope, and not the camera or computing system involved. Camera fitments for optical microscopes are inexpensive and commonly available. Assemblage and operations of these components requires no particular skill or collateral knowledge. Hence, the present invention is free of constraints entailing otherwise from capital, operation and maintenance costs besides negating the requirement of trained skilled operators for implementation of the present invention.

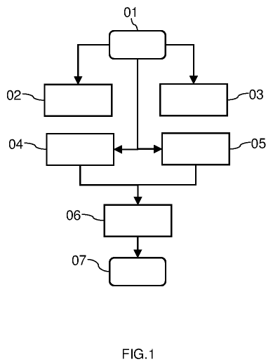

General logic for implementation of the present invention is now described with reference to FIG. 1 which shows an exemplary use-case of the present invention, described herein after in format of a standard operating protocol/executable software named “ipvMorpho” intended to be executed by the user, said protocol being manifested via different interactive user interfaces programmed within ipvMorpho. Said executable software may be hosted on the cloud, and made available in the SaaS model of implementation (that is, the executable software is provisioned for execution on the computer by either between a standalone installation and online access from a cloud server in a software-as-a-service model).

At the outset, implementation of ipvMorpho is programmed to manifest via the following modes, selectable at instance of the user via suitable on-screen interfaces, including—
a) Software Training Mode (02)
b) Particle Training Mode (03)
c) Particle Detection Mode (04)
d) Particle Classification in AI Mode (05)

Foremost in the Software Training Mode, the user (technician) initializes/starts (01) ipvMorpho, to trigger the presentation of an initial interface via which the user is prompted (via suitable on-screen controls such as switches or continuous sliders) to select an image quality mode among options poor, average and good. This is for training of the system to benchmark image quality.

Once the image quality is set to ‘good’, the system proceeds to capture 100 images of higher values in terms of Brightness, Contrast and Sharpness. These images are stored as a memo and thus benchmarked by the system as to a ‘good’ quality of captured images for reference in further operative cycles of ipvMorpho.

Once the image quality is set to ‘average’, the system proceeds to capture 100 images of higher values in terms of Brightness, Contrast and Sharpness. These images are stored as a memo and thus benchmarked by the system as to a ‘average’ quality of captured images for reference in further operative cycles of ipvMorpho.

Once the image quality is set to ‘poor’, the system proceeds to capture 100 images of higher values in terms of Brightness, Contrast and Sharpness. These images are stored as a memo and thus benchmarked by the system as to a ‘poor’ quality of captured images for reference in further operative cycles of ipvMorpho.

In the Particle Detection Mode, the user is prompted (via suitable on-screen controls such as switches or continuous sliders) to select a particle identification method by selecting among—
a) Contour based method
b) Edge based method

Once particle identification method is chosen, the user is further prompted (via suitable on-screen controls or fillable fields) to define particle detection parameters such as particle size range, particle sharpness and agglomeration threshold.

At this juncture, the microscopic field may be viewed live by switching ON the live image mode. Image quality, benchmarked for quality as per the foregoing discussion, is automatically detected and displayed on screen. As part of programmed logic, an intelligent message is prompted on the screen to improve the quality should the image quality conform to any of the ‘poor’ or ‘average’ type.

As a fallout of image quality determination and logic mentioned above, a ‘good’ quality image is assuredly captured from which ipvMorpho detects and classifies isolated particles and agglomerates as disclosed later in this document. ipvMorpho furthermore computes the statistics of size distribution shape analysis based on said data which is displayed to the user/recorded for further use.

For detection and classification of particles, the applicant has proposed a machine learning approach wherein the system learns from prior history of readings/precedents to thus automatically detect and classify isolated particles and agglomerates with increasing precision and accuracy in subsequent operative cycles/reading instances in a manner disclosed hereinafter.

In the Particle Training Mode, the user is prompted (via suitable on-screen controls such as switches or continuous sliders) to select a particle training method by selecting among—
a) Particle type name
b) Particle marking color

A detected particles tray is thus obtained by implementing the particle identification method opted. This data is used to form a Particle Classification Table, in which the particles to be trained are shown in the tray against which columns are shown for each particle type intended. Format of this presentation is designed to allow the user to then drag particles from tray and drop in proper particle type to therefore train the system of each particle type to be detected.

The above step is repeated for more than 100 particles in each type, to thus generate data sufficient for trend setting, which completes the current instance of the Particle Training Mode, which forms the reference for the Particle classification in AI mode.

To classify the particles seen in a photomicrographic view, the user is prompted (via suitable on-screen controls such as switches or continuous sliders) to select a image quality mode and particle classification mode which are now trained as per the foregoing narration. Once images are thus captured using image quality mode recommendation of ‘good’ quality, the image quality parameter software modifies the particle detection parameters automatically and detects the particles.

Therefore by a software-driven process, the detected particles are classified as isolated particles and agglomerates on the basis of set parameters. Particle features such as size, shape and texture are extracted, on which Particle Classification Model is applied to classify the detected particle in defined particle types. ipvMorpho furthermore computes statistics of each particle type and size distribution so determined.

Finally, ipvMorpho is programmed to output a report (06) of all the details of particle classification and statistics so arrived at, to thus end (07) one operation cycle for a given sample being processed.

As will be generally realized, applicability and/or performance of the present invention is not designed to be dependent on any particular sample composition and/or preparation techniques. Accordingly, the present invention is able to process photomicrographic images of samples including dry powder, liquid, gel, jelly, aerosols, emulsions, suspension, dispersion and so on and in practice, has been observed to provide results in few seconds.

As will be realized further, the present invention is capable of various other embodiments and that its several components and related details are capable of various alterations, all without departing from the basic concept of the present invention which will be limited only by the claims accompanying the non-provisional application intended to be submitted further to these presents.

We claim:

1) An artificial intelligence based method for detection and analysis of image quality and particles viewed through a microscope, comprising—
a) Constituting an application environment by communicatively associating an optical microscope to a computer, wherein—
The artificial intelligence based method for detection and analysis of image quality and particles viewed through a microscope is provisioned for execution, as an executable software, on said computer; and
the optical microscope is outfitted with a digital camera for capturing images from the field of view of said microscope and relaying said captured images in real time to said computer for processing by the executable software provisioned on said computer.
b) Foremost defining at instance of the user via a computer user interface of the executable software, a mode of operation selected among—
Software Training Mode
Particle Detection Mode, which generates detected particles trays.
Particle Training Mode, which generates data sufficient as reference for Particle classification in AI mode.
article Classification AI Mode
c) In accordance with the mode of operation opted by the user in step b), causing the corresponding sub-process to be implemented.

2) The artificial intelligence based method for detection and analysis of image quality and particles viewed through a microscope according to claim 1, wherein the sub-process corresponding to Software Training Mode comprises—
a) Defining at instance of the user, via a computer user interface of the executable software consisting of suitable on-screen controls such as switches or continuous sliders, an image quality mode selected among poor, average and good.
b) Upon choice of image quality mode, capturing one hundred images of the microscopically viewed sample and storing said images for future reference in memory of the computer under folder name benchmarked corresponding to the image quality mode chosen among poor, average and good.

3) The artificial intelligence based method for detection and analysis of image quality and particles viewed through a microscope according to claim 1, wherein the sub-process corresponding to Particle Detection Mode comprises—
a) Defining at instance of the user, via a computer user interface of the executable software, choice of particle identification method to be chosen between a contour based method and an edge based method.
b) Upon choice of particle identification method, further defining at instance of the user via a computer user interface of the executable software, a set of scanning parameters being opted among particle size range, particle sharpness and agglomeration threshold.
c) Switching on the live microscopic view of the sample as captured by the digital camera, to thereby detect its image quality in comparison to reference images stored in the Software Training Mode;
d) In the event the quality of the live microscopic view imagery conforms to either between average or poor quality reference images, disallowing said imagery for further photomicrographic processing along with displaying, on-screen, a message for opting to a better resolution; and
e) In the event that the live microscopic view imagery conforms to the good quality reference images, allowing said imagery to constitute a detected particles tray.

4) The artificial intelligence based method for detection and analysis of image quality and particles viewed through a microscope according to claim 1, wherein the sub-process corresponding to Particle Training Mode comprises—
a) Defining at instance of the user, via a computer user interface of the executable software, choice of particle training method to be chosen between a particle type name, and particle marking color.
b) Constituting a Particle Classification Table using data from the detected particles tray to allow the user to drag particles from tray and drop in proper particle type to therefore train the system of each particle type to be detected.
c) Repeating step b) one hundred times for each particle type to be detected to thereby generate data sufficient as reference for Particle classification in AI mode.

5) The artificial intelligence based method for detection and analysis of image quality and particles viewed through a microscope according to claim 1, wherein the sub-process corresponding to Particle Classification in AI Mode comprises—
a) Defining at instance of the user, via a computer user interface of the executable software consisting of suitable on-screen controls such as switches or continuous sliders, an image quality mode and particle classification mode which are priorly trained as per sub-processes of claims 2, 3 and 4.
b) In accordance with logic of the executable software, causing the automatic categorization as either between isolated particles and agglomerates and further therein, automatic classification of particles in the captured imagery on basis of their determined features such as size, shape and texture; and
c) Generating a report containing the statistics of each particle type and size distribution so determined in the sample under processing.

6) The artificial intelligence based method for detection and analysis of image quality and particles viewed through a microscope according to claim 1, wherein the executable software is provisioned for execution on the computer by either between a standalone installation and online access from a cloud server in a software-as-a-service model.
